(19) United States
(12) Patent Application Publication
(10) Pub. No.: US 2026/0058682 A1
(43) Pub. Date: Feb. 26, 2026

(54) ANALOG JAMMER DETECTION FOR AUTOMATIC GAIN CONTROL (AGC)

(71) Applicant: QUALCOMM Incorporated, San Diego, CA (US)

(72) Inventors: Balasubramanian RAMACHANDRAN, Hyderabad (IN); Abhishek Ananthrao KULKARNI, Gulbarga (IN); Tsai-Chen HUANG, Mountain View, CA (US); Francesco GATTA, San Diego, CA (US)

(21) Appl. No.: 18/815,091

(22) Filed: Aug. 26, 2024

(51) Int. Cl. H04B 1/10; H04K 3/00

(52) U.S. Cl. CPC H04B 1/1027; H04K 3/40

(57) ABSTRACT

Certain aspects of the present disclosure are directed towards techniques and apparatus for wireless communication. An example apparatus generally includes: a processor comprising a gain control component, a receive chain coupled to the processor and comprising an amplifier, and a first signal detector coupled to the receive chain and including an input coupled to an input or an output of the amplifier, wherein the gain control component includes a first input coupled to an output of the first signal detector and an output coupled to a gain control input of the amplifier.

### TECHNICAL FIELD

Certain aspects of the present disclosure generally relate to wireless communication and, more particularly, to techniques for automatic gain control (AGC).

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include one or more amplifiers for signal amplification, such as a low-noise amplifier (LNA) for amplifying a signal for further processing.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide various advantages.

Certain aspects of the present disclosure are directed towards an apparatus for wireless communication. The apparatus generally includes: a processor comprising a gain control component; a receive chain coupled to the processor and comprising an amplifier; and a first signal detector coupled to the receive chain and including an input coupled to an input or an output of the amplifier, wherein the gain control component includes a first input coupled to an output of the first signal detector and an output coupled to a gain control input of the amplifier.

Certain aspects of the present disclosure are directed towards a method for wireless communication. The method generally includes: receiving a first signal via an antenna; amplifying the first signal via an amplifier of a receive chain to generate an amplified signal; detecting, via a first signal detector, a jammer signal at an input or an output of the amplifier; and adjusting, via a gain control component, a gain of the amplifier based on the jammer signal.

Certain aspects of the present disclosure are directed towards a wireless device. The wireless device generally includes: an antenna; a receive chain coupled to the antenna and including an amplifier; a processor coupled to the receive chain and including a gain control component; and a signal detector coupled to the receive chain and including an input coupled to an input or an output of the amplifier, wherein the gain control component includes an input coupled to an output of the signal detector and an output coupled to a gain control input of the amplifier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 is a block diagram of a receiver with automatic gain control (AGC), in accordance with certain aspects of the present disclosure.

FIG. 5 is a flow diagram illustrating example operations for wireless communication, in accordance with certain aspects present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards a jammer detector (also referred to herein as a “JDET”) configured to detect a jammer signal at an input (or output) of a low-noise amplifier (LNA) of a receive chain for automatic gain control (AGC). A signal amplified by the LNA may be down-converted via a mixer. The down-converted signal may be filtered via a baseband filter (BBF), then converted via an analog-to-digital converter (ADC) from an analog signal to a digital signal for processing. A wideband energy estimate (WBEE) component may be used to detect the power (or energy) at an input or an output of the ADC for adjacent channel interference (ACI) detection. In some aspects, a jammer signal detected at an input or an output of the LNA may be used along with the ACI for AGC.

The signal measured by the WBEE component for ACI detection may be filtered using one or more filters (e.g., including the BBF) for out-of-band noise removal. That is, the signal measured via the WBEE component may be filtered through an analog filtering chain, and thus, any jammer signal that could impact the LNA may not be detected by the WBEE component. For instance, far-off channels in WiFi (e.g., WiFi channels that are far from the operating band of the receive chain) may be filtered by the BBF and the associated jammer signal may not be detected by the WBEE component. Thus, gain adjustment based on ACI may not be triggered resulting in the LNA being saturated due to the jammer signal. Moreover, the front-end (FE) rejection (e.g., filtering) between the antenna and the input of the LNA may be insufficient to prevent the LNA from saturating due to the jammer signal. Thus, in some aspects, the AGC may be implemented using a combination of the jammer signal detected at the input or the output of the LNA along with the ACI. Based on the combination of the ACI and the jammer signal at the input or output of the LNA, the gain of the LNA may be adjusted in an attempt to prevent the LNA from saturating, as described in more detail herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration. ” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

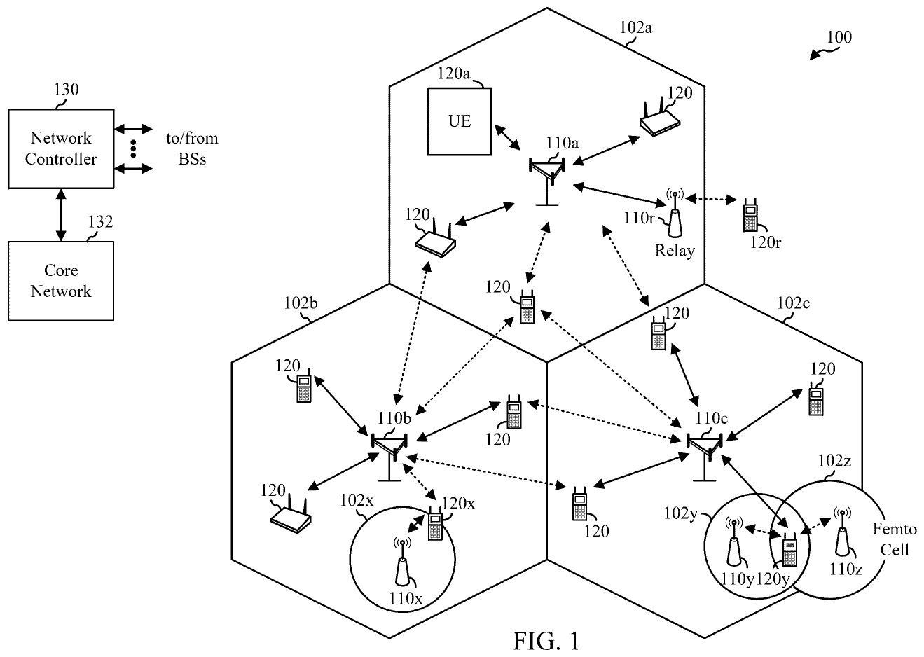

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipment's (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In some aspects, the BS 110a and/or the UE 120a may include a jammer detector for detecting a jammer signal at an input or an output of a low-noise amplifier (LNA) for automatic gain control (AGC), as described in more detail herein.

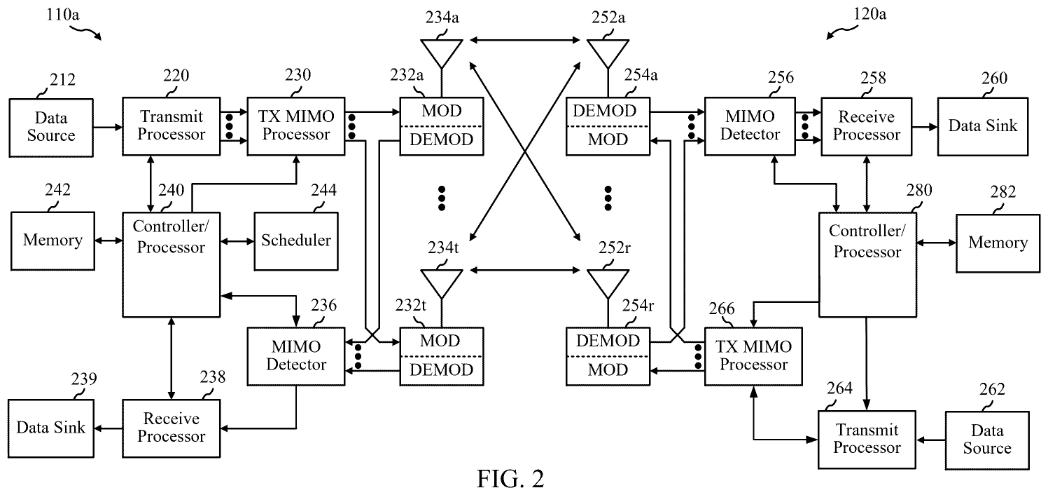

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In some aspects, the transceivers 232a-232t or transceivers 254a-254r may include a jammer detector for detecting a jammer signal at an input or an output of an LNA for AGC, as described in more detail herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

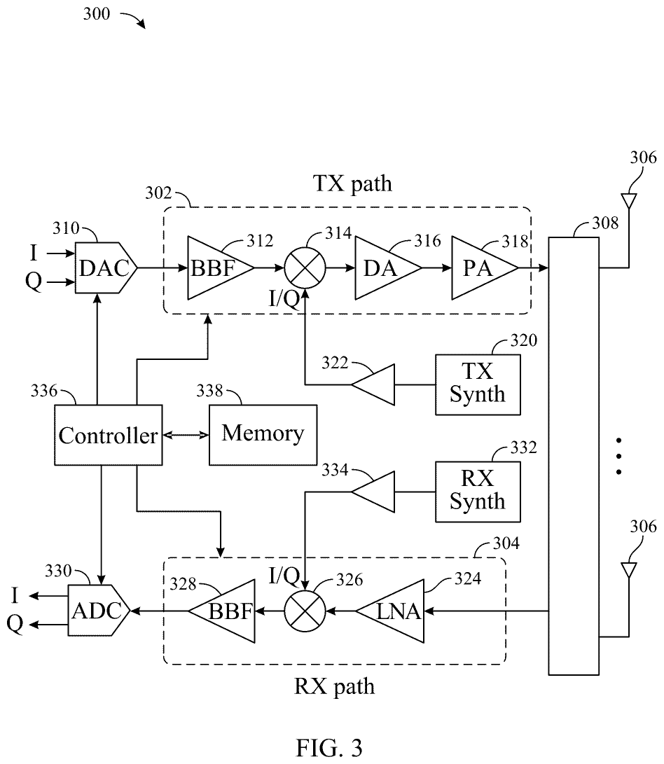

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing. In some aspects, a jammer detector may be used to detect a jammer signal at an input or an output of the LNA 324 for AGC, as described in more detail herein.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency divider/multiplier that is driven by an oscillator (e.g., a VCO) in the frequency synthesizer.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example Techniques for Analog Jammer Detection for Automatic Gain Control (AGC)

Certain aspects of the present disclosure are directed towards the detection of a jammer signal in the analog domain, where the jammer signal detection is used along with adjacent channel interference (ACI) for analog gain control (e.g., automatic gain control (AGC)). For example, transmissions in a WiFi band or a Bluetooth band may cause interference (e.g., due to a jammer signal) to other bands, such as an n40 band (e.g., 2300 to 2400 MHz) or an n41 band (e.g., 2496 to 2690 MHz). However, the jammer signal may be rejected by the BBF (e.g., BBF 328 shown in FIG. 3) and not detected using a wideband energy estimator (WBEE) component for AGC. Since the jammer signal may be undetected, gain adjustment for a low-noise amplifier (LNA) of the receiver may not be triggered, and the jammer signal may saturate the LNA because the filtering in the radio frequency (RF) front end (RFFE) between the receive antenna and the input of the LNA may not be sufficient to filter the jammer signal to avoid saturation at the LNA's unadjusted gain setting. For instance, the RFFE filtering for far-off channels (e.g., channels such as WiFi with a bandwidth far from an operating band of the receiver) may be insufficient to prevent LNA saturation. As a result of failing to detect the jammer signal and adjust the LNA gain accordingly, the gain of the LNA may be set to a level that may result in the LNA being saturated. The LNA saturation may occur for various aggressor bands and operating bands, such as an n40 transmission band causing LNA saturation for an n41 receive band or vice versa.

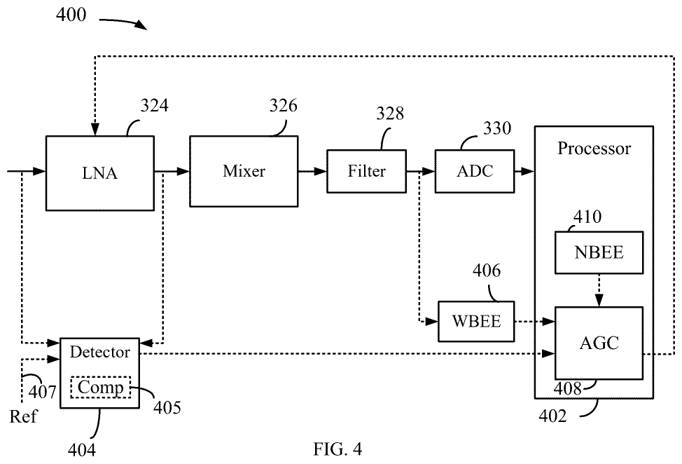

FIG. 4 is a block diagram of a receiver 400 with AGC, in accordance with certain aspects of the present disclosure. As shown, the receiver 400 may include a receive chain having a wideband energy estimate (WBEE) component 406 that may be used to perform a wideband power (or energy) measurement at the input of the ADC 330. In some cases, the WBEE component 406 may perform the power measurement at the output of the ADC. The digital signal from the ADC 330 may be provided to a processor 402 for processing. The processor may include one or more narrowband energy estimate (NBEE) components 410 providing an energy or power estimate for each of one or more carriers, respectively. That is, each of the one or more NBEE components may measure a narrow band signal, and the WBEE may measure a wideband signal that has a wider bandwidth than the narrow band signal. An AGC component 408 may identify ACI based on the measurements from the WBEE and NBEE components (e.g., based on the difference between the measurements from the WBEE and NBEE components). The ACI may be used to control the gain of the LNA 324, and in some cases, one or more digital gains applied for carrier signal processing via processor 402. For instance, an output of the AGC component 408 may be coupled to a gain control input of the LNA 324. If ACI is greater than a threshold, the AGC component 408 may determine that a jammer signal is present, and the LNA gain may be reduced in an attempt to prevent the LNA from saturating. However, in some cases, the ACI may be below a threshold that would trigger LNA gain adjustment due to the jammer signal being filtered by the filter 328. As a result, the jammer signal may not be detected, and saturation of the LNA may occur.

In some aspects of the present disclosure, the receiver 400 may include a jammer detector 404 in the analog domain, which may measure the power at the input (or output) of the LNA 324, as shown. The measurement from the detector 404 may be provided to the AGC component 408 for AGC (e.g., for controlling the gain of the LNA 324). For example, the output signal of the detector 404 may be processed to generate a power signal (e.g., in dBm), where the processed signal is provided to the AGC component 408 for AGC. In some aspects, a received signal strength indicator (RSSI) may be calculated using the ACI and jammer measurement from detector 404 and used to determine whether to adjust the gain of the LNA.

If the ACI is not valid (e.g., ACI is less than an ACI threshold), but the jammer power measurement from detector 404 is equal to or greater than a jammer threshold, the analog LNA gain may be reduced. For example, the LNA gain may be set based on the RSSI calculated based on a sum of the power measurement from detector 404 and the ACI. The RSSI may be calculated as the ACI plus a scaled version of the jammer power measurement from detector 404 plus the in-band power measurement (e.g., measurement from the one or more NBEE components 410). Suppose the ACI is not valid (e.g., ACI is less than an ACI threshold) and the jammer power measurement from detector 404 is less than the jammer threshold. In that case, the AGC may be performed based on the in-band power measurement (e.g., based on measurement(s) from one or more NBEE components 410).

If the ACI is valid (e.g., ACI is greater than the ACI threshold) and the jammer power measurement from detector 404 is less than the jammer threshold, the AGC component 408 may determine that a jammer signal exists (e.g., although not detected by detector 404), and the ACI may be used for AGC. If the ACI is valid and the jammer power measurement from detector 404 is equal to or greater than the jammer threshold, the larger of the ACI and the jammer power measurement from detector 404 may be used for calculating the RSSI for AGC. That is, the RSSI may be calculated based on the ACI or the jammer signal detected by detector 404, whichever corresponds to a higher power or energy.

In some aspects, the detector 404 may be implemented as a comparator 405, which may compare the signal at the input (or the output) of the LNA 324 with a reference signal (e.g., representing a jammer threshold) at a reference node 407 to detect whether the jammer signal exists. For example, when the voltage at the input of the LNA reaches the level of the reference signal, the output signal of the detector 404 may transition from logic low to logic high. In some aspects, the jammer signal level that would result in the LNA saturating may be characterized and used to set the reference signal. In some aspects, the reference signal level may be adjusted to identify the level of the jammer signal. For example, the voltage of the reference signal may be swept, and when the output signal of detector 404 transitions from logic low to logic high while the reference signal is being swept, the level of the jammer signal may be determined. The reference signal may be set so that a low-level jammer signal that would not saturate the LNA would be ignored.

While FIG. 4 illustrates AGC techniques for a single receive chain to facilitate understanding, aspects of the present disclosure may be implemented for any suitable number of chains. For example, the detector 404 and WBEE component 406 may be implemented for each of multiple receive chains and used for AGC.

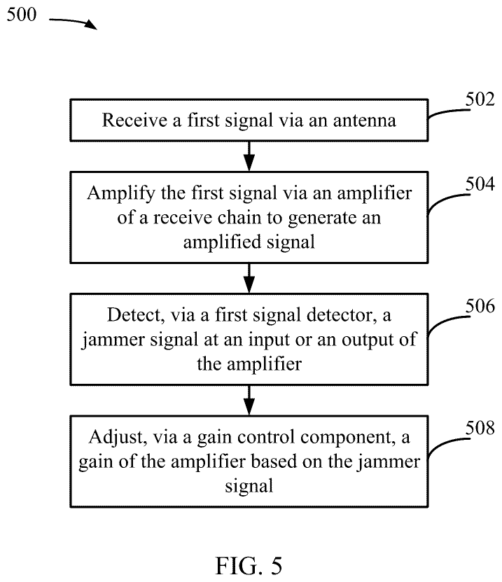

FIG. 5 is a flow diagram illustrating example operations 500 for wireless communication, in accordance with certain aspects present disclosure. The operations 500 may be performed, for example, by a receiver such as the receiver 400.

At block 502, the receiver may receive a signal via an antenna. At block 504, the receiver may amplify the signal via an amplifier (e.g., LNA 324) of a receive chain to generate an amplified signal. At block 506, the receiver may detect, via a first signal detector (e.g., detector 404), a jammer signal at an input or an output of the amplifier. At block 508, the receiver may adjust, via a gain control component (e.g., AGC component 408), a gain of the amplifier based on the jammer signal. The gain control component may also be referred to as “gain control logic. ”

Detecting the jammer signal at block 506 may include comparing the jammer signal with one or more jammer thresholds and outputting a jammer signal indicator based on the comparison. The gain of the amplifier may be adjusted at block 508 based on the jammer signal indicator.

In some aspects, the receiver may down-convert (e.g., via mixer 326) the amplified signal to generate a down-converted signal, filter (e.g., via filter 328) the down-converted signal to generated a filtered signal, and convert the filtered signal to a digital signal via an analog-to-digital converter (ADC). In some aspects, the receiver may detect a signal at an input or an output of the ADC. The gain of the amplifier may be adjusted further based on the signal. The signal at the input or the output of the ADC may include a wideband signal detected via a wideband energy estimate (WBEE) component (e.g., WBEE component 406). The receiver may also detect, via a narrowband energy estimate (NBEE) component (e.g., one or more NBEE components 410), a narrowband signal based on a digital output signal of the ADC. The narrowband signal may be characterized by a narrower frequency band as compared to the wideband signal. The receiver may calculate adjacent channel interference (ACI) based on the narrowband signal and the wideband signal. The gain of the amplifier may be adjusted based at least in part on the jammer signal and the ACI.

The receiver may calculate ACI based on the signal at the input or the output of the ADC, where the gain of the amplifier is adjusted based on the ACI and the jammer signal. For example, the receiver may calculate a RSSI based on the ACI and the jammer signal. The gain of the amplifier may be adjusted based on the RSSI. The receiver may detect that the jammer signal is greater than a jammer threshold and the ACI is less than an ACI threshold. The RSSI may be calculated based on the ACI and the jammer signal in response to the detection.

In some aspects, the receiver may detect that the jammer signal is greater than a jammer threshold and the ACI is greater than an ACI threshold. In response to the detection, the receiver may calculate an RSSI based on one of the ACI and the jammer signal corresponding to a higher power or energy. The gain of the amplifier may be adjusted based on the RSSI.

### Example Aspects

In addition to the various aspects described above, specific combinations of aspects are within the scope of the present disclosure, some of which are detailed below:

Aspect 1: An apparatus for wireless communication, comprising: a processor comprising a gain control component; a receive chain coupled to the processor and comprising an amplifier; and a first signal detector coupled to the receive chain and including an input coupled to an input or an output of the amplifier, wherein the gain control component includes a first input coupled to an output of the first signal detector and an output coupled to a gain control input of the amplifier.

Aspect 2: The apparatus of Aspect 1, wherein: the receive chain further comprises an analog-to-digital converter (ADC); the apparatus further comprises a second signal detector comprising an input coupled to an input or an output of the ADC; and the gain control component includes a second input coupled to an output of the second signal detector.

Aspect 3: The apparatus of Aspect 1 or 2, wherein the gain control component is configured to adjust a gain of the amplifier based at least in part on an output signal of the first signal detector.

Aspect 4: The apparatus according to any of Aspects 1-3, wherein the receive chain further comprises: a mixer comprising an input coupled to an output of the amplifier; a filter comprising an input coupled to an output of the mixer; and an analog-to-digital converter (ADC) comprising an input coupled to an output of the filter.

Aspect 5: The apparatus according to any of Aspects 1-4, wherein the first signal detector is configured to detect a jammer signal at the input or the output of the amplifier, and wherein the gain control component is configured to adjust a gain of the amplifier based on the jammer signal.

Aspect 6: The apparatus according to any of Aspects 1-5, wherein the first signal detector comprises a comparator having a first input coupled to the input or the output of the amplifier and a second input coupled to a reference node.

Aspect 7: The apparatus according to any of Aspects 1-6, wherein: the receive chain further comprises an analog-to-digital converter (ADC); and the apparatus further comprises a wideband energy estimate (WBEE) component configured to detect a wideband signal at an input or an output of the ADC.

Aspect 8: The apparatus of Aspect 7, further comprising a narrowband energy estimate (NBEE) component configured to detect a narrowband signal based on a digital output signal of the ADC, the narrowband signal having a narrower band as compared to the wideband signal.

Aspect 9: The apparatus of Aspect 8, wherein the gain control component is configured to: calculate adjacent channel interference (ACI) based on the narrowband signal and the wideband signal; and adjust a gain of the amplifier based at least in part on an output signal of the first signal detector and the ACI.

Aspect 10: The apparatus according to any of Aspects 1-9, wherein: the receive chain further comprises an analog-to-digital converter (ADC); the apparatus further comprises a second signal detector including an input coupled to an input or an output of the ADC; and the gain control component is configured to: calculate adjacent channel interference (ACI) based on an output signal of the second signal detector; and adjust a gain of the amplifier based on the ACI and an output signal of the first signal detector.

Aspect 11: The apparatus of Aspect 10, wherein the gain control component is configured to: calculate a received signal strength indicator (RSSI) based on the ACI and the output signal of the first signal detector; and adjust the gain of the amplifier based on the RSSI.

Aspect 12: The apparatus of Aspect 11, wherein the gain control component is configured to: detect that the output signal of the first signal detector is greater than a jammer threshold and the ACI is less than an ACI threshold; and calculate the RSSI based on the ACI and the output signal of the first signal detector in response to the detection.

Aspect 13: The apparatus according to any of Aspects 10-12, wherein the gain control component is configured to: detect that the output signal of the first signal detector is greater than a jammer threshold and the ACI is greater than an ACI threshold; calculate, in response to the detection, a received signal strength indicator (RSSI) based on one of the ACI and the output signal of the first signal detector corresponding to a higher power or energy; and adjust the gain of the amplifier based on the RSSI.

Aspect 14: A method for wireless communication, comprising: receiving a first signal via an antenna; amplifying the first signal via an amplifier of a receive chain to generate an amplified signal; detecting, via a first signal detector, a jammer signal at an input or an output of the amplifier; and adjusting, via a gain control component, a gain of the amplifier based on the jammer signal.

Aspect 15: The method of Aspect 14, wherein detecting the jammer signal comprises: comparing the jammer signal with one or more jammer thresholds; and outputting a jammer signal indicator based on the comparison, the gain of the amplifier being adjusted based on the jammer signal indicator.

Aspect 16: The method of Aspect 14 or 15, further comprising: down-converting the amplified signal to generate a down-converted signal; filtering the down-converted signal to generated a filtered signal; converting the filtered signal to a digital signal via an analog-to-digital converter (ADC); and detecting a second signal at an input or an output of the ADC, the gain of the amplifier being adjusted based further on the second signal.

Aspect 17: The method of Aspect 16, wherein the second signal at the input or the output of the ADC comprises a wideband signal detected via a wideband energy estimate (WBEE) component.

Aspect 18: The method of Aspect 17, further comprising detecting, via a narrowband energy estimate (NBEE) component, a narrowband signal based on a digital output signal of the ADC, the narrowband signal having a narrower band as compared to the wideband signal.

Aspect 19: The method of Aspect 18, further comprising calculating adjacent channel interference (ACI) based on the narrowband signal and the wideband signal, wherein the gain of the amplifier is adjusted based at least in part on the jammer signal and the ACI.

Aspect 20: The method according to any of Aspects 16-19, further comprising calculating adjacent channel interference (ACI) based on the second signal at the input or the output of the ADC, wherein the gain of the amplifier is adjusted based on the ACI and the jammer signal.

Aspect 21: The method of Aspect 20, further comprising calculating a received signal strength indicator (RSSI) based on the ACI and the jammer signal, wherein the gain of the amplifier is adjusted based on the RSSI.

Aspect 22: The method of Aspect 21, further comprising detecting that the jammer signal is greater than a jammer threshold and the ACI is less than an ACI threshold, wherein the RSSI is calculated based on the ACI and the jammer signal in response to the detection.

Aspect 23: The method according to any of Aspects 20-22, further comprising: detecting that the jammer signal is greater than a jammer threshold and the ACI is greater than an ACI threshold; and in response to the detection, calculating a received signal strength indicator (RSSI) based on one of the ACI and the jammer signal corresponding to a higher power or energy, wherein the gain of the amplifier is adjusted based on the RSSI.

Aspect 24: A wireless device, comprising: an antenna; a receive chain coupled to the antenna and including an amplifier; a processor coupled to the receive chain and including a gain control component; and a signal detector coupled to the receive chain and including an input coupled to an input or an output of the amplifier, wherein the gain control component includes an input coupled to an output of the signal detector and an output coupled to a gain control input of the amplifier.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. An apparatus for wireless communication, comprising:
a processor comprising a gain control component;
a receive chain coupled to the processor and comprising an amplifier; and
a first signal detector coupled to the receive chain and including an input coupled to an input or an output of the amplifier, wherein the gain control component includes a first input coupled to an output of the first signal detector and an output coupled to a gain control input of the amplifier.

2. The apparatus of claim 1, wherein:
the receive chain further comprises an analog-to-digital converter (ADC);
the apparatus further comprises a second signal detector comprising an input coupled to an input or an output of the ADC; and
the gain control component includes a second input coupled to an output of the second signal detector.

3. The apparatus of claim 1, wherein the gain control component is configured to adjust a gain of the amplifier based at least in part on an output signal of the first signal detector.

4. The apparatus of claim 1, wherein the receive chain further comprises:
a mixer comprising an input coupled to an output of the amplifier;
a filter comprising an input coupled to an output of the mixer; and
an analog-to-digital converter (ADC) comprising an input coupled to an output of the filter.

5. The apparatus of claim 1, wherein the first signal detector is configured to detect a jammer signal at the input or the output of the amplifier, and wherein the gain control component is configured to adjust a gain of the amplifier based on the jammer signal.

6. The apparatus of claim 1, wherein the first signal detector comprises a comparator having a first input coupled to the input or the output of the amplifier and a second input coupled to a reference node.

7. The apparatus of claim 1, wherein:
the receive chain further comprises an analog-to-digital converter (ADC); and
the apparatus further comprises a wideband energy estimate (WBEE) component configured to detect a wideband signal at an input or an output of the ADC.

8. The apparatus of claim 7, further comprising a narrowband energy estimate (NBEE) component configured to detect a narrowband signal based on a digital output signal of the ADC, the narrowband signal having a narrower band as compared to the wideband signal.

9. The apparatus of claim 8, wherein the gain control component is configured to:
calculate adjacent channel interference (ACI) based on the narrowband signal and the wideband signal; and
adjust a gain of the amplifier based at least in part on an output signal of the first signal detector and the ACI.

10. The apparatus of claim 1, wherein:
the receive chain further comprises an analog-to-digital converter (ADC);
the apparatus further comprises a second signal detector including an input coupled to an input or an output of the ADC; and
the gain control component is configured to:
calculate adjacent channel interference (ACI) based on an output signal of the second signal detector; and
adjust a gain of the amplifier based on the ACI and an output signal of the first signal detector.

11. The apparatus of claim 10, wherein the gain control component is configured to:
calculate a received signal strength indicator (RSSI) based on the ACI and the output signal of the first signal detector; and
adjust the gain of the amplifier based on the RSSI.

12. The apparatus of claim 11, wherein the gain control component is configured to:
detect that the output signal of the first signal detector is greater than a jammer threshold and the ACI is less than an ACI threshold; and
calculate the RSSI based on the ACI and the output signal of the first signal detector in response to the detection.

13. The apparatus of claim 10, wherein the gain control component is configured to:
detect that the output signal of the first signal detector is greater than a jammer threshold and the ACI is greater than an ACI threshold;
calculate, in response to the detection, a received signal strength indicator (RSSI) based on one of the ACI and the output signal of the first signal detector corresponding to a higher power or energy; and
adjust the gain of the amplifier based on the RSSI.

14. A method for wireless communication, comprising:
receiving a first signal via an antenna;
amplifying the first signal via an amplifier of a receive chain to generate an amplified signal;
detecting, via a first signal detector, a jammer signal at an input or an output of the amplifier; and
adjusting, via a gain control component, a gain of the amplifier based on the jammer signal.

15. The method of claim 14, wherein detecting the jammer signal comprises:
comparing the jammer signal with one or more jammer thresholds; and
outputting a jammer signal indicator based on the comparison, the gain of the amplifier being adjusted based on the jammer signal indicator.

16. The method of claim 14, further comprising:
down-converting the amplified signal to generate a down-converted signal;
filtering the down-converted signal to generated a filtered signal;
converting the filtered signal to a digital signal via an analog-to-digital converter (ADC); and
detecting a second signal at an input or an output of the ADC, the gain of the amplifier being adjusted based further on the second signal.

17. The method of claim 16, wherein the second signal at the input or the output of the ADC comprises a wideband signal detected via a wideband energy estimate (WBEE) component.

18. The method of claim 17, further comprising detecting, via a narrowband energy estimate (NBEE) component, a narrowband signal based on a digital output signal of the ADC, the narrowband signal having a narrower band as compared to the wideband signal.

19. The method of claim 18, further comprising calculating adjacent channel interference (ACI) based on the narrowband signal and the wideband signal, wherein the gain of the amplifier is adjusted based at least in part on the jammer signal and the ACI.

20. A wireless device, comprising:
an antenna;
a receive chain coupled to the antenna and including an amplifier;
a processor coupled to the receive chain and including a gain control component; and
a signal detector coupled to the receive chain and including an input coupled to an input or an output of the amplifier, wherein the gain control component includes an input coupled to an output of the signal detector and an output coupled to a gain control input of the amplifier.
